(19) United States
(12) Patent Application Publication
(10) Pub. No.: US 2004/0128204 A1
(43) Pub. Date: Jul. 1, 2004

(54) Systems for procuring products in a distributed system

(76) Inventors: Virgil F. Cihla, Pekin, IL (US); Beth A. Koehl, Mackinaw, IL (US)

Correspondence Address: Finnegan, Henderson, Farabow,, Garrett & Dunner, L.L.P., 1300 I Street, N.W., Washington, DC, 20005-3315, US

(21) Appl. No.: 10/330,018

(22) Filed: Dec. 27, 2002

(51) Int. Cl. G06F 17/60

(52) U.S. Cl. 705/26

(57) ABSTRACT

Methods and systems for facilitating a transaction between a procurement system associated with a customer and an order fullfillment system associated with a provider are provided. In one embodiment, the method may include receiving, from the procurement system, a purchase order for at least one product supplied by the provider. The purchase order may be processed to enable the order fulfillment system to interpret the purchase order and route the purchase order to a provider resource. Additionally, information associated with the transaction may be stored and provided to a requesting entity that performs at least one analysis process based on the stored information.

### TECHNICAL FIELD

This invention relates generally to data communications systems, and more particularly to systems, methods, and articles of manufacture for integrating customer procurement systems with automated order fulfillment systems maintained by providers.

### BACKGROUND

The advent of the Internet has played an integral role in shaping the modern commercial landscape. Many commercial transactions, especially merchandise dealings, are now performed on-line rather than in person. Through electronic commerce (“e-commerce”), the Internet has enhanced the ability for commercial players (e.g., buyers, sellers, suppliers, etc.) to interact during such transactions. The profusion of on-line products and services provides enormous convenience to consumers. And by exploiting the features of e-commerce, businesses can streamline many aspects of their practices, such as supply chain management. For example, attempts have been made to use aspects of the Internet to streamline reverse logistic flows.

Utilizing aspects of e-commerce, some product suppliers have developed automated product ordering systems that enable customers to purchase products via the Internet. Additionally, in industries where suppliers provide their products to consumers through dealerships, business information systems have emerged. Such systems employ aspects of e-commerce to, for example, facilitate communication and product exchange between various dealerships, manage inventory levels, link new systems with legacy systems, and manage customer relations.

On the customer side, procurement systems have emerged that allow products and services to be directly acquired from various sources (e.g., dealerships) via the Internet. Such systems help reduce the costs associated with procuring products and services endured by customers. Examples of procurement systems include those provided by Ariba, Inc. and Commerce One Operations, Inc. Certain procurement systems involve web-based catalogues (e.g., primary catalogues) which include products and services marketed by various suppliers. A single primary catalogue may contain catalogues from multiple companies (secondary catalogues). Using primary catalogues, consumers may access, review, and purchase products offered by different suppliers from a single location.

Despite the emergence of provider and customer-based automated systems, several difficulties continue to exist with product procurement. For instance, primary catalogues are usually ineffective for companies that offer a large number of products (e.g., a few thousand). One solution to this problem is to link a primary catalogue to the secondary catalogues of other companies, rather than actually hosting the secondary catalogues. An example of this solution is described in U.S. Pat. No. 6,016,504 to Arnold et al. The '504 patent describes a “virtual outlet” system that provides a web page that includes product information provided by one or more merchants. The system allows a customer to link to a merchant web page for additional product information and to order the product. Although the virtual outlet system described in the '504 patent allows customers to directly access merchant web pages through a primary catalogue, the system does not account for companies with exceedingly large numbers of products. Also, the virtual outlet system does not account for sellers which have multiple secondary catalogues hosted on separate computing platforms.

In addition to the deficient handling of large inventories of products, existing systems also lack the ability to support fully automated procurement processes. Often, customer-based procurement systems and provider-based business systems (e.g., dealer business systems) are not fully compatible. That is, provider-based systems may utilize certain information and data types not supported by the customer's procurement system. Thus, most conventional systems require a certain a degree of human intervention in procuring products. Moreover, conventional procurement systems lack the ability to route purchase orders to one of several sources associated within a provider's infrastructure.

Software packages have emerged for handling business-to-business (B2B) processing, that is, integrating customer systems with provider infrastructures. Examples of such systems include IBM® CrossWorlds, 12, and packages available from Vignette® Corp. However, theses systems are deficient in several aspects. Existing B2B systems lack the ability to effectively link applications across varying security measures and networks. Conventional B2B systems also lack support for data formatting and error handling. In addition, existing B2B systems lack the ability to handle complex business transactions such as sourcing and dealership selection.

Methods, systems, and articles of manufacture consistent with certain embodiments of the present invention are directed to solving one or more of the problems set forth above.

### SUMMARY OF THE INVENTION

Systems and methods may be provided for facilitating transactions between a customer procurement system and a provider infrastructure. In one embodiment, a process may be provided for enabling a customer to procure products from a provider via a procurement system. Methods may be provided for receiving, from the procurement system (e.g., a web-based application), a purchase order for one or more products supplied by the provider. The purchase order may be processed so that an order fulfillment system maintained by the provider can interpret the purchase order. The order fulfillment system may route the purchase order to a provider resource, such as a dealership. In exemplary embodiments of the instant invention, information reflecting purchases may be tracked, logged, and organized to enable queries and business analyses to be performed by customers and providers.

### BRIEF DESCRIPTION OF THE DRAWINGS

In the drawings:

FIG. 1A is a block diagram illustrating an exemplary system consistent with certain embodiments of the present invention;

FIG. 1B is an exemplary screen shot consistent with certain embodiments of the present invention;

FIG. 1C is another block diagram illustrating an exemplary system consistent with certain embodiments of the present invention;

FIG. 2 shows an exemplary integration module consistent with certain embodiments of the present invention;

FIG. 3 is a flowchart depicting an exemplary procurement process consistent with certain embodiments of the present invention;

FIG. 4 is a flowchart depicting another exemplary procurement process consistent with certain embodiments of the present invention; and

FIG. 5 illustrates a listing of exemplary data fields consistent with certain embodiments of the present invention.

### DETAILED DESCRIPTION

In the following detailed description reference will be made to the accompanying drawings, in which like numerals represent like elements throughout the figures. The accompanying figures illustrate exemplary embodiments of the present invention, which are described in sufficient detail to enable those skilled in the art to practice the invention. It is to be understood that other implementations may be utilized and that structural and method changes may be made without departing from the scope of present invention. The following discussion is, therefore, not to be construed in a limiting sense.

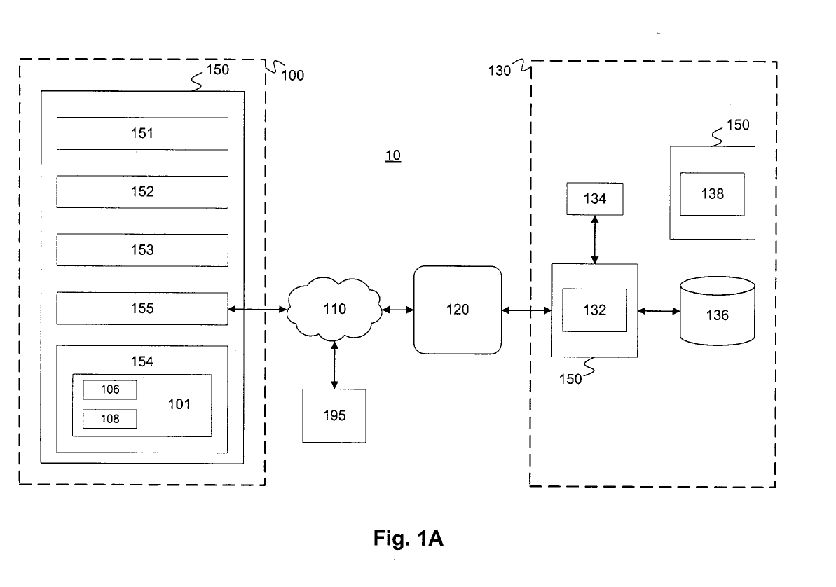

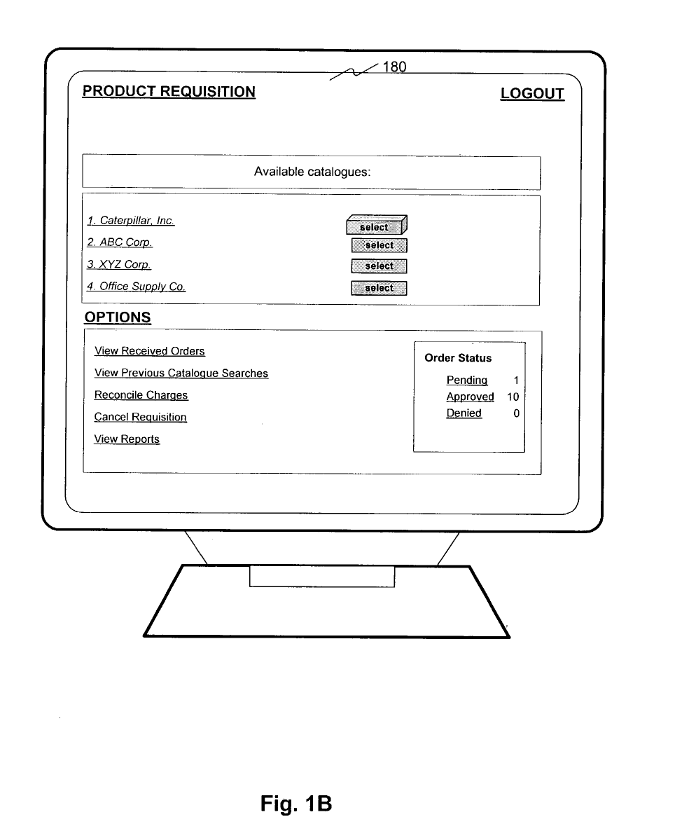

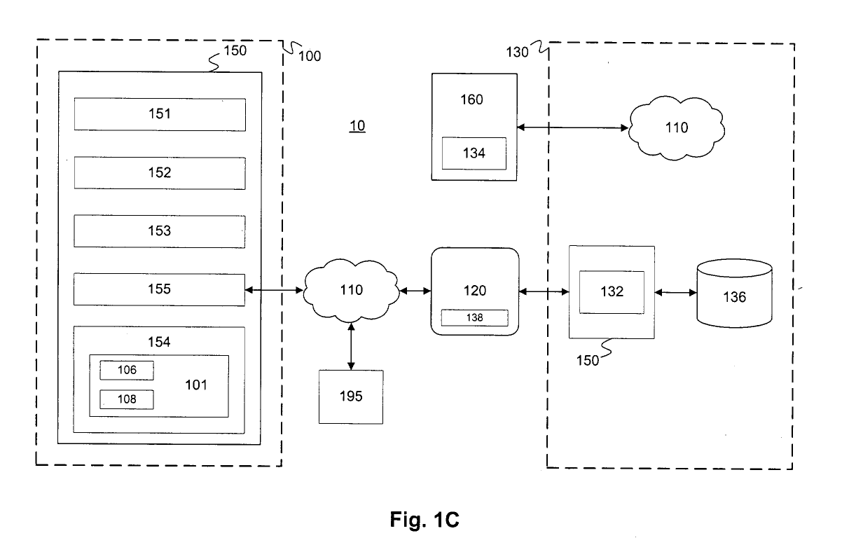

FIG. 1A illustrates an exemplary system 10 in which features and principles of the present invention may be implemented. In one embodiment of the invention, system 10 may include a customer infrastructure 100, a network 110, an integration module 120, a provider infrastructure 130, and a user access system 195.

Customer procurement infrastructure 100 may include any combination of components, devices, and mechanisms used by a customer for procuring a product. As used herein the term “customer” refers to any entity that procures a product including, but not limited to, individual consumers, corporate consumers, private organizations, public organizations, and/or governmental organizations. A “product” refers to any tangible and/or intangible good or service designed, developed, manufactured, supplied, delivered, and/or made available for rent or purchase by a provider. Products may include, but are not limited to, mechanical parts, electronic components, electrical systems, building materials, industrial/commercial products/parts, chemicals, vehicles, machines, natural resources, pharmaceutical items, medical equipment, defense systems, computer devices, office supplies, furniture, and/or personnel and other human resources. In one non-limiting example, products may be associated with industrial systems, such as front end loaders, tractors, and other equipment. Products may also include intangible elements, such as electronically transmitted information, human knowledge, business initiatives, program code, PROM pass codes, and/or financial instruments (e.g., loans and stocks). Further, products may include services, such as mechanical, construction, installation, health care, and financial services. As used herein, the term “provider” refers to any entity that designs, develops, manufactures, distributes, delivers, markets, and/or offers for sale or rent one or more products. Thus, a provider may include one or more of a corporation, a partnership, firm, enterprise, service provider, manufacturer, supplier, distributor, dealership, wholesaler, retailer, educational institution, and a government agency.

As FIG. 1A illustrates, customer infrastructure 100 may include a data processing system 150, which may be used for procuring products. As used herein, the term “procure” refers to purchasing, ordering, renting, leasing, subscribing, retrieving, and/or any other transaction performed by a customer to acquire a product. One particular combination of components that could reside in data processing system 150 includes a display device 151, input device 152, processor 153, memory 154, and a network interface 155. Non-limiting examples of data processing system 150 include a laptop computer, desktop computer, server, workstation, or mainframe. Although a single data processing system 150 is illustrated, customer infrastructure 100 may include a number of data processing systems 150. Moreover, data processing system 150 may lack certain illustrated components and/or contain, or be coupled to, additional components (not shown).

In one embodiment of the present invention, data processing system 150 may include display device 151, which may be any type of output device configured to output data (e.g., text, images, code, or any other type of information). For example, display device 151 may include a cathode ray tube, liquid crystal, light-emitting diode, gas plasma, or other type of display mechanism. Display device 151 may be used in conjunction with input device 152 to enable a user operating data processing system 150 to interact with one or more processes executed by system 150.

Input device 152 may be any type of input mechanism used to provide data to data processing system 150, such as a keyboard, a mouse, and/or a touch screen. Input device 152 may additionally or alternatively include a data reading device and/or an input port.

Processor 153 may be one or more devices operatively configured to execute program instructions. Processor 153 may be configured for routing information among components and devices and for retrieving and executing computer instructions, code, etc. stored in memory 154.

Memory 154 may be any mechanism capable of storing information including, but not limited to, RAM, ROM, magnetic and optical storage, organic storage, audio disks, and video disks. Although a single memory device 154 is shown, any number of memory devices may be included in data processing system 150, each configured for performing distinct functions associated with customer infrastructure 100.

In one embodiment, memory 154 may include a customer procurement module 101 that may be program code that, when executed by processor 153, performs one or more procurement processes. Customer procurement module 101 may further include an e-procurement application 106 and an Enterprise Resource Planning (ERP) module 108. In one embodiment of the present invention, e-procurement application 106 may be program code that performs, when executed by processor 153, a web-based product procurement process. E-procurement application 106 may also be program code that, when executed by processor 153, performs an interactive computer application that supports various customer transactions (e.g., requests to purchase a product, etc.). In addition, e-procurement system 106 may include or may access one or more electronic catalogues (e.g., a primary catalogue) which may include information associated with one or more product providers. FIG. 1B shows an exemplary screen shot of a web page (180) including a list of catalogues associated with a number of different product providers. Web page 180 may also include one or more options that allow a user to view and manage previously submitted, pending, and current orders.

Additionally, or alternatively, customer procurement system 101 may include or be coupled to ERP module 108. ERP 108 may be any type of information system for managing customer resources and automatically detecting and fulfilling customer needs. In one embodiment, ERP 108 may be program code executed by processor 153.

Although FIG. 1A shows e-procurement module 106 and ERP 108 as modules within customer procurement module 101, modules 106 and 108 may be implemented within separate and/or remote data processing systems 150. Moreover, modules 106 and 108 may be distributed among any number of data processing systems 150 within customer infrastructure 100. Alternatively, or additionally, e-procurement application 106 and/or ERP 108 may be implemented within their own data processing systems including processing and memory devices for executing program code.

In certain embodiments of the instant invention, a customer may access e-procurement application 106 and/or ERP 108 directly from data processing system 150. For example, data processing system 150 may be a workstation used by the customer. In alternative embodiments, a customer may access e-procurement application 106 and/or ERP 108 indirectly via a remotely located access terminal 195 coupled to network 110. Access terminal 195 could include components similar to those described in connection with data processing system 150 or may have varying, additional, or less components. For instance, access terminal 195 may include a personal computer, mobile computing device (e.g., a PDA), mobile communications device (e.g., a cell phone), or any other structure that enables a user to remotely access information. Access terminal 195 could even be a kiosk or “dumb” terminal coupled to data processing system 150.

As FIG. 1A illustrates, data processing system 150 may be connected to network 110 via network interface 155, which may be operatively connected via a wired and/or wireless communications link. Network interface 155 may be any mechanism for sending information to and receiving information from network 110, such as a network card and an Ethernet port, or to any other network such as an attached Ethernet LAN, serial line, etc.

Network 110 may be the Internet, a virtual private network, a broadband digital network, a local area network (LAN), a wide area network (WAN), a dedicated intranet, or any other structure for enabling communication between two or more remote locations. Network 110 may include one or more wired and/or wireless based connections. Network 110 may also employ communication protocols such as HyperText Transfer Protocal (HTTP), Transmission Control and Internet Protocol (TCP/IP), Asynchronous Transfer Mode (ATM), Ethernet, or any other compilation of procedures for controlling communications among network locations. Customer infrastructure 100 may be operatively connected to network 110 by one or more communication devices and software, such as those commonly employed by Internet Service Providers (ISPs) or as part of an Internet gateway. Systems and devices coupled to and included in network 110 may be assigned network identifiers (ID), which may, in one configuration, be encoded as IP addresses. As used herein, the term “ID” refers to any symbol, value, tag, or identifier used for addressing, identifying, relating, or referencing a particular network device.

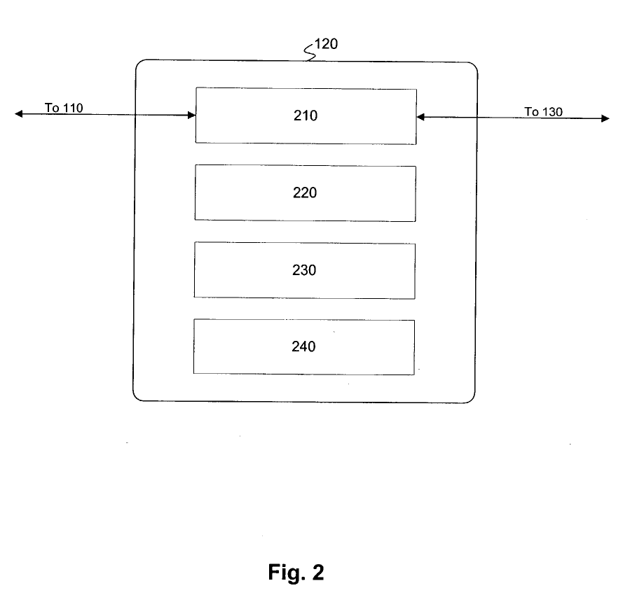

In one embodiment, integration module 120 may serve as an integration layer that enables one or more customer procurement systems 101 to directly procure products from one or more providers. Integration module 120 may be any device, system, mechanism, and/or compilation of software processes for integrating customer procurement system 101 with provider infrastructure 130. In exemplary embodiments of the invention, integration module 120 may include, or be coupled to, one or more switches, routers, and or memory devices. Integration module 120 may also include one or more modem cards for dial-in users, gateway cards for connections to local area networks, and connecting devices coupled to outgoing lines. Integration module 120 may also include one or more logic-based processes and/or components to support business transactions between customer procurement system 101 and provider infrastructure 130. The details of such transactions, as well as exemplary features and components of integration module 120, will be discussed below in connection with FIG. 2. For clarity of explanation, integration module 120 is depicted, in FIG. 1A, external to provider infrastructure 130. However, integration module may be included within provider infrastructure 130.

As mentioned above, integration module 120 may facilitate business transactions between customer procurement system 101 and provider infrastructure 130. Provider infrastructure 130 may include any combination of logic-based components, hardware devices, data processing devices, information systems, private networks or intranets, and/or communication components interconnecting various resources associated with a provider and configured to support business transactions with one or more customers. For example, as illustrated in FIG. 1A, provider infrastructure 130 may include an electronic catalogue 132, a product information database 136, an order fulfillment system 134, and a security system 138.

In exemplary embodiments of the instant invention, provider infrastructure 130 may include one or more data processing systems 150 on which one or more of electronic catalogue 132, order fulfillment system 134, database 136, and security system 138 may reside or be distributed. For example, as illustrated in FIG. 1A, electronic catalogue 132 and security system 138 could reside on single data processing systems, while a Dealer Business System (the details of which are described below) is distributed throughout a network of dealerships, each having an independent data processing system (not illustrated). In addition, electronic catalogue 132, order fulfillment system 134, database 136, and security system 138 may represent their own data processing systems including hardware and software configured to execute one or more processes.

In one embodiment of the invention, electronic catalogue 132 may be an application that serves as an interface through which customers may access resources within provider infrastructure 130 and obtain information related to products associated with a given provider. Electronic catalogue 132 may also be configured to receive orders for products from customers. In one configuration, product information (e.g., technical specifications, graphics, schematics, technical drawings, customer-specific price, etc.) may be maintained on one or more storage mechanisms, such as database 136. As used herein, the term “database” refers to any type of memory device that maintains and stores information such as a relational database, distributed database, object-oriented programming database. Although FIG. 1A depicts a single database 136 residing in infrastructure 130, a plurality of databases may implemented within, or extended to, provider infrastructure 130.

Order fulfillment system 134 may be one or more information systems that interact with one or more provider resources to fulfill customer orders for one or more products. A provider resource is any entity associated with a provider's supply chain. In one embodiment, a provider resource is an entity associated with a provider of one or more products, such as, but not limited to, a dealership, warehouse, distributor, manufacturer, manufacturing plant, research facility, business unit, factory, retailer, and/or rental agency. Order fulfillment system 134 may be configured to route customer orders to specific provider resources, manage product inventory, manage shipping and billing, and/or manage customer relations.

In exemplary embodiments, order fulfillment system 134 may include a Dealer Business System (DBS) through which a plurality of geographically dispersed resources (e.g., dealerships) may be linked. DBS may be an information system configured to facilitate communication within dealerships, manage product inventory, handle order fulfillment, manage customer relationships, and/or facilitate product exchange between dealerships and/or other resources. In one embodiment, DBS may use one or more networks, similar in structure to network 110, to facilitate communications between provider resources.

Security system 138 may include one or more devices, mechanisms, and/or software processes configured to protect resources and information within provider infrastructure 130. Security system 138 may be configured to perform various functions such as data encryption and decryption and/or user authentication. Thus, security system 138 may include, or be coupled to, a public key infrastructure (PKI) employing public key cryptography. In exemplary embodiments, security system 138 may be configured to establish a secure layer between one or more resources associated with a provider and an outside network (e.g., network 110) to prevent customers from directly accessing systems and data included in provider infrastructure 130. Security system 138 may also be configured to establish and maintain one or more firewalls to protect a provider resources and proprietary information. Further, security system 138 may include or be coupled to one or more proxy servers that initiate network requests and processes on behalf of one or more users.

Although FIG. 1A depicts a single customer infrastructure 100, a single procurement system 101, and a single provider infrastructure 130, system 10 may include any number of procurement systems 101 and infrastructures 100 and 130. Integration module 120 could therefore be configured to interact with several customer procurement systems 101 and several provider infrastructures 130 simultaneously. In addition, for clarity of explanation, system 10 is described herein with reference to the discrete functional elements illustrated in FIG. 1A. However, it should be understood that the functionality of these elements and modules may overlap and/or may exist in fewer elements and modules. For example, within provider infrastructure 130, elements 132, 134, 136, and 138 may be combined into a single module that includes software, hardware, and/or a combination of both. Likewise, within customer procurement system 101, elements 106 and 108 may, in fact, reside in a single package. Moreover, all or part of the functionality of the elements illustrated in FIG. 1A may co-exist or be distributed among several geographically dispersed locations. And system 10 may include additional or fewer modules than those depicted in FIG. 1A. For example, provider infrastructure may include or be coupled to one or more systems and/or infrastructures, which may interact with customer procurement system 101 and manufacturer logistic processes to locate parts not currently in a particular dealer's inventory or to retrieve information for parts a dealer has not yet handled.

In one embodiment of the invention, system 10 may be configured as depicted in FIG. 1C. As illustrated in FIG. 1C, all or part of the functionality of security system 138 may reside in integration module 120 instead of provider infrastructure 130. Further, infrastructure 130 may be a corporate entity and be coupled via a network 110 to a provider 160, located external to infrastructure 130. Provider 160 may be any entity or system for fulfilling customer orders and may include, or be coupled to, order fulfillment system 134. In one embodiment, provider 160 may include all or part of the functionality associated with provider infrastructure 130.

As mentioned above, integration module 120 serves as an integration layer that enables one or more customers to procure one or more products from a given provider directly from customer procurement system 101. FIG. 2 shows an exemplary integration module 120 consistent with embodiments of the present invention. As illustrated in FIG. 2, integration module 120 may include a communications interface 210, an application integration module 220, a transaction processing module 230, and a business processing module 240.

Communications interface 210 may be one or more devices and/or mechanisms (e.g., hardware, software, or a combination thereof) for sending and receiving information to/from network 110, as well as provider infrastructure 130. In one embodiment, communications interface 210 may include a network card and an Ethernet port to facilitate communications with other devices or mechanisms connected to network 110 or another network, such as an attached Ethernet LAN, serial line, etc (not shown). In exemplary embodiments of the invention, communications interface 210 may include one or more network interfaces which could be operatively connected via wired and/or wireless communications links. Further, communications interface 210 may additionally include one or more data ports for transmitting data in various modes of transmission, such as serial transmission and parallel transmission.

In exemplary embodiments of the instant invention, the eXtendable Markup Language (XML) may be employed to facilitate the data exchange between integration module and other entities to which it is coupled (e.g., provider infrastructure 130, network 110, etc). Additionally, or alternatively, the Standard Generalized Markup Language (SGML) and/or any other language that facilitates the creating and sharing of common information formats may be employed.

Application integration module 220 may be a data processing component and/or software that facilitates and manages the exchange of information among and between one or more customer and provider systems. In one embodiment of the invention, application integration module 220 may include one or more components and/or processes, implemented in software (e.g., Java) and/or hardware, for performing functions, such as receiving and transmitting data, translating data, handling data security, managing system messages, handling errors and controlling failures, controlling and monitoring production, and/or managing events. In one embodiment, application integration module 220 may include all or part of the functionality of security system 138. Further, application integration module 220 may receive information from customer procurement system 101 (via network 110) in, for example, an XML format and translate the received data such that the data can be interpreted and processed by provider infrastructure 130.

Transaction processing module 230 may include one or more components and processes, implemented in software (e.g., Java) and/or hardware, for capturing, processing, and/or reporting information. Transaction processing module 230 may be configured to capture errors (e.g. exceptions), capture transaction data, manage SQL (Structured Query Language) queries, and/or provide a graphical user interface (GUI) for user interaction with integration module 120. Transaction processing module 230 may facilitate On-line Analytical Processing (OLAP) and may support multi-dimensional analyses of data and may enable calculations and modeling across dimensions as well as trend analysis over various time periods. For example, transaction processing module 230 may organize data hierarchically, enabling users to explore detailed information (e.g., details of a specific transaction), as well as broader views (e.g., overall spending, customer satisfaction, etc). Transaction processing module 230 may also dynamically change combinations of dimensions being viewed by a user. Further, transaction processing module 230 may extract, collect, organize, and store data from various sources, such as On-line Transaction Processing (OLTP) applications, for use by analytical applications. In exemplary embodiments, transaction processing module 230 may store and organize information associated with transactions between customers and providers to enable a customer and/or provider to perform one or more analysis processes, such as cost/benefit analyses, market analyses, and/or a strategic business analyses. Transaction processing module 230 may also facilitate data warehousing which includes data replication, data transformation, data quality assurance, data storage, metadata storage, and data mart population (i.e., populating specific databases within a data warehouse).

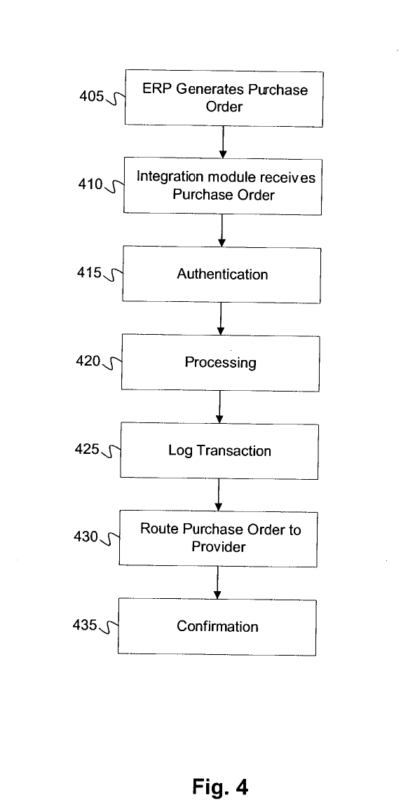

Business processing module 240 may include one or more components and processes, implemented in software (e.g., Java) and/or hardware, configured to manage various business processes, such as dealership selection, shipping management, price and availability retrieval, invoice review, billing and settlement, workflow management, and/or sourcing. In addition, business processing module 240 may be configured to format and process data received from customer procurement system 101 for use by order fulfillment system 134. Additional details of business processing module 240 will be discussed below with respect to FIG. 4.

For clarity of explanation, communications interface 210, application integration module 220, transaction processing module 230, and business processing module 240 are described herein as discrete functional elements. It should, however, be understood that the functionality of these modules may overlap and/or may exist in one or more fewer modules. Moreover, all or part of the functionality of the elements illustrated in integration module 120 may co-exist or be distributed among several geographically dispersed locations. And integration module 120 may include additional or fewer modules than those depicted in FIG. 2. Further, one or more of the modules (or components therein) residing in integration module 120 may be scalable in order to accommodate additional services, data, customers and/or providers.

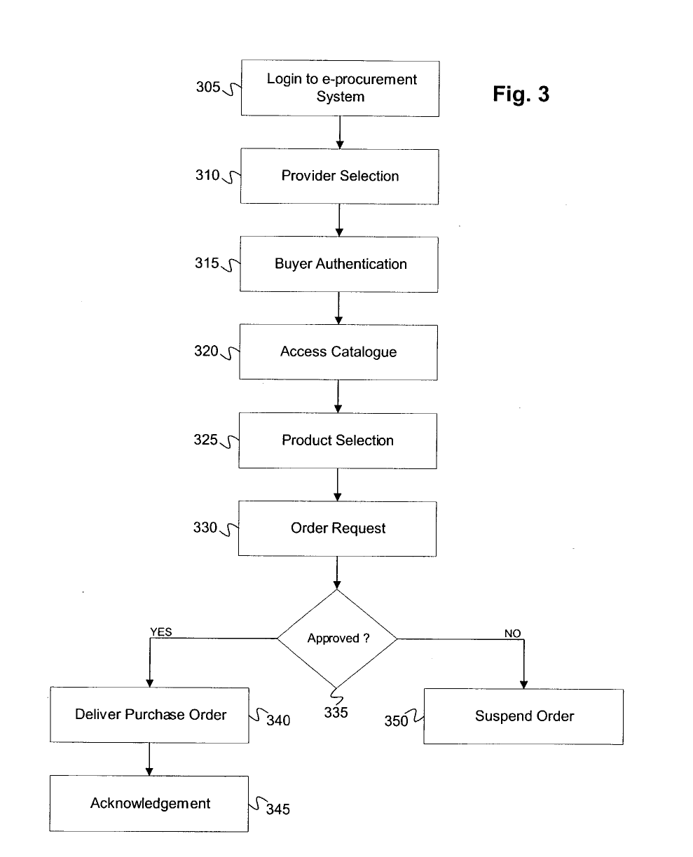

As described, a user may procure, via customer procurement system 101, one or more products from one or more providers. FIG. 3 shows a flowchart of an exemplary procurement process. As illustrated, the procurement process may begin when a user associated with a customer procurement system 101 initiates a session (e.g., logs in) with e-procurement application 106 (step 305). In one embodiment of the invention, a user may gain access to e-procurement application 106 by providing identification information (e.g., a username and password) directly to data processing system 150. In other embodiments, a user may remotely access e-procurement application 106 from access terminal 195 via network 110 by providing identification information to browser software. After logging in, a user may select, via e-procurement application 106, a provider from which to obtain one or more products (step 310). In one embodiment, e-procurement application 106 may generate and provide content (e.g., web page) including a list of one or more providers that offer one or more products. The content may be presented to the user, via data processing system 150 and/or access terminal 195, such that the user may select one or more of the providers from the content.

Once a user selects a given provider(s), e-procurement application 106 may generate and route a request (e.g., a data packet) to integration module 120. Upon receiving the request, integration module 120 may translate the request to a format understandable by provider infrastructure 130, via application integration module 220. The translated request may then be provided to provider infrastructure 130.

In one embodiment, integration module 120 may leverage application integration module 220 to authenticate the user (step 315). When successfully authenticated, a user may be provided with access to electronic catalogue 132 (step 320). Integration module 120 may provide e-procurement application 106 with access to electronic catalogue 132 via application integration module 220. For example, the user may be linked, via network 110, to electronic catalogue 132. Electronic catalogue 132 may generate and/or provide a list of one or more products offered by one or more providers. Using electronic catalogue 132, the user may select one or more products for purchase (step 325).

Once the user selects a product for purchase, electronic catalogue 132 may generate and route an Order Request (OR) to integration module 120 (step 330). The OR may reflect the user's desire to purchase the one or more products selected in step 325 and may include information associated with the user and the selected products. For example, the OR may include user identification information, product type and quantity, total purchase price, etc. Integration module 120 may receive and translate the OR, and then route the OR back to e-procurement application 106 for approval. For example, e-procurement application 106 may verify that the user is authorized to purchase the type and number of products selected based on, for example, employee status, funding, etc. If the user is not authorized to perform the requested transaction (step 335; No), the order may be suspended, canceled, or routed to another person for approval (step 350). In one embodiment, integration module 120 may track and record this event via transaction processing module 230.

If, however, the requesting user is authorized to perform the desired transaction (step 335; Yes), then a Purchase Order (PO) may be generated by customer procurement system 101 and routed, via integration module 120, to order fulfillment system 134 (e.g., DBS). The PO may, for example, contain information associated with the customer, provider, product, price, and/or shipping requirements. In exemplary embodiments, e-procurement application 106 may be pre-configured with information associated with pre-established customer-dealership relationships and/or preferred provider resources. The customer-dealer relationships and preferred resources may be based on various criteria including customer and provider locations, customer language preferences, price, and/or specific business agreements between customers and providers. Accordingly, the PO may contain information indicating a specific resource from which to obtain the selected products. For example, the PO may include information specifying a specific dealership from which to procure the selected product(s).

Upon receiving the PO, order fulfillment system 134 may route the PO to the appropriate resource within provider infrastructure 130 (step 340). In one embodiment of the invention, order fulfillment system 134 may allow a given resource (e.g., dealership) to exchange PO's and/or acquire products from other resources. Order fulfillment system 134 may manage order fulfillment and generate a confirmation indicating receipt of the purchase. In step 345, the confirmation may be routed to integration module 120 and then transmitted to the customer therefrom. In exemplary embodiments of the invention, integration module 120 may track the purchase and/or log the completed order for subsequent access via transaction processing module 230. For example, transaction processing module 230 may log and organize information associated with the purchase (e.g., customer ID, customer location, provider ID, price, quantity, etc.) and allow customers and providers to initiate queries for and perform business analyses on (e.g., via an analysis application) this information.

FIG. 4 shows a flowchart of another exemplary procurement process. As shown, the procurement process may begin when ERP 108 automatically generates a PO for one or more products associated with a provider (step 405). In one embodiment, ERP 108 may periodically retrieve or be pre-programmed with a portion of the information included in electronic catalogue 132 and/or database 136, thereby enabling ERP 108 to identify, and include in the PO, specific information associated with one or more products, such as price and availability. Once the PO is generated, ERP 108 may transmit the PO to integration module 120. Upon receiving the PO (step 410), integration module 120 may authenticate the PO via application integration module 220 (step 415). In addition, integration module 120 may process the PO via business processing module 240 (step 420). Processing may include, for example, interpreting the received PO for order fulfillment system 134. In one embodiment of the invention, order fulfillment system 134 may be configured to receive a data packet that includes various data fields to process a purchase.

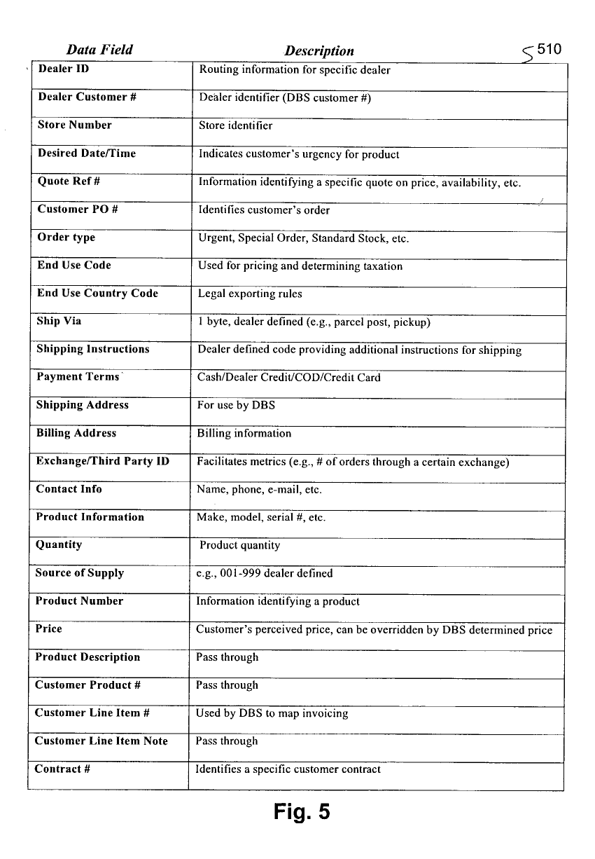

FIG. 5 shows a listing 510 of exemplary data fields and corresponding descriptions. In some instances, ERP 108 and/or e-procurement application 106 may not support or may not have sufficient information to fill all of the data fields required by the order fulfillment system. That is, the PO may not contain all of the data expected by order fulfillment system 134 (e.g., the PO may be missing one or more of the data fields illustrated in FIG. 5). Accordingly, business processing module 240 may be configured to process a received PO such that the PO can be utilized by order fulfillment system 134. For example, business processing module 240 may fill in missing data fields using default values stored in a pre-established customer profile maintained by business processing module 240 and/or order fuilfillment system 134. Alternatively or additionally, business processing module 240 may capture the missing data from other transactions (via transaction processing module 230) and merge the captured data into the PO when it arrives at integration module 120.

After processing the PO, integration module 120 may log the transaction via transaction processing module 230 (step 425). Integration module 120 may then route the PO to order fulfillment system 134, which in turn may route the PO to the appropriate resource associated with provider infrastructure 130 (step 430). In certain embodiments, order fulfillment system 134 may reconcile any discrepancies between information included in the PO and information included in database 136. For example, if the price of a product included in the PO is inconsistent with the actual price of the product, order fulfillment system 134 may simply override the price in the PO or, alternatively, generate and send a message to integration module 120 indicating the discrepancy and requesting further instructions. Integration module 120 may then route the message back to ERP 108, which may suspend, cancel, and/or approve the order, depending on the discrepancy. Assuming, no discrepancies exist, or the order is approved notwithstanding a discrepancy, a confirmation message may be transmitted to integration module 120 and then routed to ERP 108 therefrom, as indicated by step 435. Any discrepancies overridden without requesting approval from the customer may be indicated in the confirmation message. Integration module 120 may log the confirmation message for subsequent reference.

### INDUSTRIAL APPLICABILITY

Methods, systems, and articles of manufacture consistent with the present disclosure allow customers to procure products from a given provider directly from a procurement system. These embodiments also serve to utilize existing services and leverage certain systems within a provider infrastructure. Further, certain disclosed embodiments may enable customers to consolidate product purchasing, streamline supply chains, and/or to perform business analyses using transaction processing module 230. In addition, clerical errors may be reduced and anytime procurement may be facilitated. The instant invention may also reduce transaction costs incurred by providers and enable providers to maximize customer relations, thereby reducing opportunity costs and increasing revenue.

The described systems and methodologies may be applied to any industry and with any type of tangible and/or intangible products. Non-limiting examples of applicable industries, with which customers and providers may be associated, include telecommunications, commercial and residential architecture and construction, electrical, mechanical, and chemical engineering, landscaping, retail, banking, finance, marketing, food services, pharmaceutics, health care, research, national defense, government, education, and/or real estate. Applicable products may include, mechanical components and systems, electrical components and systems, chemicals, food, vehicles, and/or any other tangible item(s). As described above in connection with FIG. 1A, products may also encompass services and non-physical entities.

Although the description of the processes illustrated in FIG. 3 and FIG. 4. make reference to product purchasing, the disclosed system may additionally or alternatively be used for other types of business transactions such as renting, leasing, acquiring legal rights to, and/or executing contracts for products. Also, it should be understood that the sequence of events described in FIGS. 3 and 4 are exemplary and not intended to be limiting. Thus, other method steps may be used, and even with the methods depicted in FIG. 3 and FIG. 4, the particular order of events may vary without departing from the scope of the present invention. Further, certain steps may not be present and additional steps may implemented in FIGS. 3 and 4. For example, step 420 of FIG. 4 may be included in the mode of operation depicted in FIG. 3. Moreover, the data fields illustrated in data packet 510 are exemplary only. Data packet 510 could include any number of data fields. And the data fields are not limited to any particular size or format.

In one embodiment, integration module 120 may enable a customer to procure products from provider infrastructure using e-procurement application 106. In such an embodiment, one or more customers may be provided with access to e-procurement application 106. For example, individuals associated with a corporation or enterprise may access e-procurement application 106 via data processing systems 150 or access terminals 195 included in or coupled to customer procurement infrastructure 100. In certain embodiments, access to customer procurement system 101 may be limited to specific individuals associated with a given customer. For example, department heads, managers, and/or purchasing specialists associated with a given customer may be given access, via passwords, to customer procurement system 101. However, customer procurement system 101 is not limited to any given type of customer. And customer procurement system 101 may be used by private consumers (e.g., consumers not affiliated with a business).

In another embodiment, integration module 120 may facilitate fully automated procurement transactions between ERP 108 and provider infrastructure 130. Consistent with such embodiments, human interaction may be unnecessary for performing transactions. Accordingly, ERP 108 may automatically detect or determine a customer's need for a product and be configured to automatically order the product from one or more providers.

Although a single provider infrastructure and a single customer procurement system are disclosed herein, integration module 120 may be configured to integrate any number of geographically dispersed customer procurement systems and provider infrastructures. Thus, a given customer employing customer procurement system 101 may procure products from several independent providers via one or more integration modules 120. In addition, integration module 120 may enable a given provider to conduct transactions with several independent customers.

In one embodiment, integration module 120 may reside on a data access system 150 associated with provider infrastructure 130. In alternative embodiments, integration module 120 may be maintained by an independent third party not associated with either provider infrastructure 130 or customer procurement infrastructure 100. Moreover, the features of integration module 120 may be distributed among several modules located in remote or local locations. For example, the functions of integration module 120 could be distributed among several processing modules in a private network within provider infrastructure 130.

Further, in exemplary embodiments of the invention, integration module 120 may support various queries and business analysis processes via transaction processing module 230. For example, multi-dimensional analyses of consolidated enterprise data, calculations and modeling across dimensions, and trend analysis over various time periods (e.g., for evaluating purchasing, marketing, customer satisfaction) may be performed. Integration module 120 may additionally or alternatively support measurement of one or more metrics associated with business transactions and performance. In one embodiment, both a customer and provider may initiate and perform business analysis processes. For example, a customer may analyze its order volume. Also, a provider or customer may analyze transactions in order to develop or evaluate a business model or marketing strategy. In one embodiment, customers and providers may execute one or more automated analytical applications to perform business analyses, such as OLTP applications.

Embodiments of the disclosed system may be implemented in various environments. Further, the processes described herein are not inherently related to any particular apparatus and may be implemented by any suitable combination of components. Further, various types of general purpose devices may be used in accordance with the teachings described herein.

The present invention has been described in relation to particular examples which are intended in all respects to be illustrative rather than restrictive. Different combinations of hardware, software, and firmware may be suitable for practicing embodiments of the present invention.

Additionally, other embodiments of the invention will be apparent to those skilled in the art from consideration of the specification and practice of the invention disclosed herein. It is intended that the specification and examples be considered as exemplary only. To this end, it is to be understood that inventive aspects lie in less than all features of a single foregoing disclosed embodiment, implementation, or configuration.

What is claimed is:

1. A method for facilitating a transaction between a procurement system associated with a customer and an order fulfillment system associated with a provider, comprising:
receiving, from the procurement system, a purchase order for at least one product supplied by the provider;
processing the purchase order to enable the order fulfillment system to interpret the purchase order and route the purchase order to a provider resource;
storing information associated with the transaction; and
providing the stored information to a requesting entity that performs at least one analysis process based on the stored information.

2. The method of claim 1, further including:
receiving a request to access an electronic catalogue associated with the provider, wherein the electronic catalogue includes information associated with the product; and
providing the customer with access to the electronic catalogue.

3. The method of claim 1, further including:
enabling the procurement system to periodically receive information associated with the at least one product from the order fulfillment system.

4. The method of claim 1, wherein processing the purchase order includes:
receiving the purchase order in a first data format and translating the purchase order to a second data format.

5. The method of claim 4, wherein the order fulfillment system is unable to interpret the first data format and processing the purchase order includes translating the purchase order to the second format.

6. The method of claim 1, wherein processing the purchase order includes:
receiving a data packet including at least one data field; and
modifying the data packet based on a customer profile maintained by the order fulfillment system.

7. The method of claim 6, wherein modifying includes adding a new data field to the data packet.

8. The method of claim 1, wherein processing the purchase order includes resolving at least one discrepancy between product information available to the procurement system and product information maintained by the order fulfillment system.

9. The method of claim 1, wherein the requesting entity is the customer and providing the stored information includes:
receiving a query for a portion of the stored information from the customer; and
providing the customer with the portion of the stored information in response to the query.

10. The method of claim 1, wherein the requesting entity is the provider and the at least one analysis process includes at least one of a trend analysis, a multi-dimensional analysis, and a cost benefit analysis.

11. The method of claim 1 further including:
receiving a confirmation message reflecting receipt of the purchase order by the order fulfillment system; and
routing the confirmation message to the procurement system.

12. A method for facilitating a transaction between a customer and a provider, comprising:
receiving, from a procurement system associated with the customer, a request to access an electronic catalogue maintained by the provider, said electronic catalogue including product information associated with at least one product;
providing the product information to the customer;
transmitting, to the procurement system, an order request reflecting an intention of the customer to purchase the at least one product;
receiving a purchase order for the at least one product from the procurement system based on an approval of the order request by the procurement system;
processing the purchase order to enable at least one order fulfillment system associated with the provider to interpret the purchase order;
providing the purchase order to the at least one order fulfillment system;
determining, by the at least one order fulfillment system, at least one resource associated with the provider based on the purchase order; and
transmitting a confirmation to the procurement system indicating receipt of the purchase order by said resource.

13. The method of claim 12, wherein determining at least one resource includes:
routing the purchase order to one of a plurality of dealerships supplying the at least one product.

14. The method of claim 12, wherein processing the purchase order includes:
receiving the purchase order in a first data format and translating the purchase order to a second data format.

15. The method of claim 14, wherein the at least one order fulfillment system is unable to interpret the first data format and processing the purchase order includes translating the purchase order to the second format.

16. The method of claim 12, wherein processing the purchase order includes:
receiving a data packet including at least one data field; and
modifying the data packet based on a customer profile maintained by the order fulfillment system.

17. The method of claim 16, wherein modifying includes adding a new data field to the data packet.

18. The method of claim 12, wherein processing the purchase order includes:
resolving at least one discrepancy between product information available to the procurement system and product information maintained by the order fulfillment system.

19. The method of claim 12, further including:
storing information associated with the transaction; and
providing the stored information to a requesting entity that performs at least one analysis process based on the stored information.

20. A system for facilitating a transaction between a customer and a provider that supplies a product, comprising:
a procurement application, associated with the customer, configured to enable the customer to procure a product from the provider;
a provider resource that provides the product supplied by the provider;
an integration module configured to provide the procurement application with access to information associated with the product, receive a purchase order for the product from the procurement application, and process the received purchase order; and
at least one order fulfillment system, associated with the provider, configured to interpret the processed purchase order and transmit the interpreted purchase order to the provider resource, wherein the provider resource provides the product to the customer based on the interpreted purchase order.

21. The system of claim 20, wherein the procurement application is an e-procurement application residing on at least one data processing system associated with the customer.

22. The system of claim 20, wherein the procurement application is an Enterprise Resource Planning (ERP) system residing on at least one data processing system associated with the customer.

23. The system of claim 20, wherein the system includes a plurality of provider resources associated with the provider and the order fulfillment system is an information system distributed among the provider resources.

24. The system of claim 20, wherein the provider resource includes at least one of a dealership, warehouse, distributor, retailer, manufacturer, and supplier.

25. The system of claim 24, wherein the order fulfillment system is software distributed among and executed by at least one data processing system coupled to the provider resource.

26. The system of claim 20, wherein the integration module resides on at least one data processing system associated with the provider.

27. The system of claim 20, wherein the integration module is further configured to:
store information associated with the transaction between the customer and the provider; and
providing the stored information to a requesting entity that performs at least one analysis process based on the stored information.

28. The system of claim 27, wherein the integration module is configured to receive at least one query initiated by the provider for obtaining information associated with the transaction.

29. An apparatus for facilitating a transaction between a procurement system associated with a customer and an order fulfillment system associated with a provider, comprising:
means for receiving, from the procurement system, a purchase order for at least one product supplied by the provider;
means for processing the purchase order to enable the order fulfillment system to interpret the purchase order and route the purchase order to a provider;
means for storing information associated with the transaction; and
means for providing the stored information to a requesting entity that performs at least one analysis process based on the stored information.

30. An apparatus for facilitating a transaction between a procurement system associated with a customer and an order fulfillment system associated with a provider, comprising:
a communications interface for receiving, from the procurement system, a purchase order for at least one product supplied by the provider;
an integration module for translating the purchase order to enable at least one order fulfillment system associated with the provider to interpret the purchase order;
an order processing module for manipulating the purchase order to enable the at least one order fulfillment system to deliver said purchase order to at least one resource supplying the at least one product; and
a transaction module for organizing information associated with the transaction and enabling at least one business analysis to be performed using said organized information.

31. The apparatus of claim 30, wherein the integration module translates the purchase order by receiving the purchase order in a first data format and re-formatting the purchase order to a second data format compatible with the order fulfillment system.

32. The apparatus of claim 30, wherein the order processing module is configured to:
receive a data packet including at least one data field associated with the transaction; and
use a customer profile maintained by the provider to add at least one additional data field to the data packet.

33. The apparatus of claim 30, wherein the order processing module is configured to resolve at least one discrepancy between product information available to the procurement system and product information maintained by the order fulfillment system.

34. The apparatus of claim 30, wherein the transaction module is configured to receive a query from the customer for information associated with the transaction and provide the customer with the information in response to the query.

35. The apparatus of claim 30, wherein the transaction module is configured to receive a query from the provider for information associated with the transaction and provide the provider with the information associated with the transaction in response to the query.

36. The apparatus of claim 30, wherein the transaction module is configured to provide the organized information to an analysis application that performs at least one of a trend analysis, multi-dimensional data analysis, and a cost benefit analysis based on the organized information.

37. A computer-readable medium containing instructions for controlling a computer system coupled to a network to perform a method, the computer system having a processor for executing the instructions, the method comprising:
receiving, from the procurement system, a purchase order for at least one product supplied by the provider;
processing the purchase order to enable the order fulfillment system to interpret the purchase order and route the purchase order to a provider;
storing information associated with the transaction; and
providing the stored information to a requesting entity that performs at least one analysis process based on the stored information.
